(19) United States
(12) Patent Application Publication
(10) Pub. No.: US 2026/0052452 A1
(43) Pub. Date: Feb. 19, 2026

(54) WIRELESS COMMUNICATION METHOD, AND USER EQUIPMENT

(71) Applicant: GUANGDONG OPPO MOBILE TELECOMMUNICATIONS CORP., LTD., Dongguan (CN)

(72) Inventors: Haorui YANG, Dongguan (CN); Fei LU, Dongguan (CN)

(73) Assignee: GUANGDONG OPPO MOBILE TELECOMMUNICATIONS CORP., LTD., Dongguan (CN)

(21) Appl. No.: 19/368,394

(22) Filed: Oct. 24, 2025

Related U.S. Application Data
(63) Continuation of application No. PCT/CN2023/101089, filed on Jun. 19, 2023.

(51) Int. Cl. H04W 40/24; H04W 88/04

(52) U.S. Cl. CPC H04W 40/246; H04W 88/04

(57) ABSTRACT

Provided are a wireless communication method, and a user equipment. The method comprises: a relay user equipment sending first indication information to a remote user equipment, wherein the first indication information is associated with an alarm message. In the embodiments of the present application, indication information which is associated with an alarm message is introduced, and the indication information is exchanged between a relay user equipment and a remote user equipment.

### CROSS-REFERENCE TO RELATED APPLICATIONS

This application is a continuation of International Application No. PCT/CN2023/101089, filed on Jun. 19, 2023, the disclosure of which is hereby incorporated by reference in its entirety.

### TECHNICAL FIELD

This application relates to the field of communications technologies, and more specifically, to a wireless communication method and a user equipment (UE).

### BACKGROUND

In a UE-to-network relay (U2N relay) scenario, a standard specifies that a relay UE may transmit a warning message in a broadcast manner. However, there is currently no clear solution to a specific implementation.

### SUMMARY

This application provides a wireless communication method and a user equipment. Various aspects used in this application are described below.

According to a first aspect, a wireless communication method is provided, including: transmitting, by a relay UE, first indication information to a remote UE, where the first indication information is associated with a warning message.

According to a second aspect, a wireless communication method is provided, including: receiving, by a remote UE, first indication information transmitted by a relay UE, where the first indication information is associated with a warning message.

According to a third aspect, a UE is provided, where the UE is a relay UE, and the relay UE includes: a communications module, configured to transmit first indication information to a remote UE, where the first indication information is associated with a warning message.

According to a fourth aspect, a UE is provided, where the UE is a remote UE, and the remote UE includes: a communications module, configured to receive first indication information transmitted by a relay UE, where the first indication information is associated with a warning message.

According to a fifth aspect, a UE is provided, including a transceiver, a memory, and a processor. The memory is configured to store a program, and the processor is configured to invoke the program in the memory, and control the transceiver to receive or transmit a signal, to cause the UE to perform the method according to the first aspect or the second aspect.

According to a sixth aspect, an apparatus is provided, including a processor configured to invoke a program from a memory, to cause the apparatus to perform the method according to the first aspect or the second aspect.

According to a seventh aspect, a chip is provided, and includes a processor, configured to invoke a program from a memory, to cause a device on which the chip is installed to perform the method according to the first aspect or the second aspect.

According to an eighth aspect, a computer-readable storage medium is provided, where the computer-readable storage medium stores a program, and the program causes a computer to perform the method according to the first aspect or the second aspect.

According to a ninth aspect, a computer program product is provided, and includes a program, where the program causes a computer to perform the method according to the first aspect or the second aspect.

According to a tenth aspect, a computer program is provided. The computer program causes a computer to perform the method according to the first aspect or the second aspect.

### BRIEF DESCRIPTION OF DRAWINGS

FIG. 1 is an example diagram of a system architecture of a wireless communications system to which embodiments of this application are applicable.

FIG. 2 is an architectural diagram of a core network of a new radio (NR) system.

FIG. 3 is an example diagram of a system architecture for a U2N relay.

FIG. 4 is a schematic flowchart of a discovery procedure based on a mode A.

FIG. 5 is a schematic flowchart of a discovery procedure based on a mode B.

FIG. 6 is a schematic flowchart of a wireless communication method according to an embodiment of this application.

FIG. 7 is a schematic flowchart of a possible implementation in FIG. 6.

FIG. 8 is a schematic flowchart of another possible implementation in FIG. 6.

FIG. 9 is a schematic flowchart of another possible implementation in FIG. 6.

FIG. 10 is a schematic diagram of a structure of a UE according to an embodiment of this application.

FIG. 11 is a schematic diagram of a structure of a UE according to another embodiment of this application.

FIG. 12 is a schematic diagram of an apparatus according to an embodiment of this application.

### DESCRIPTION OF EMBODIMENTS

Technical solutions in this application are described below with reference to the accompanying drawings.

### Wireless Communications System

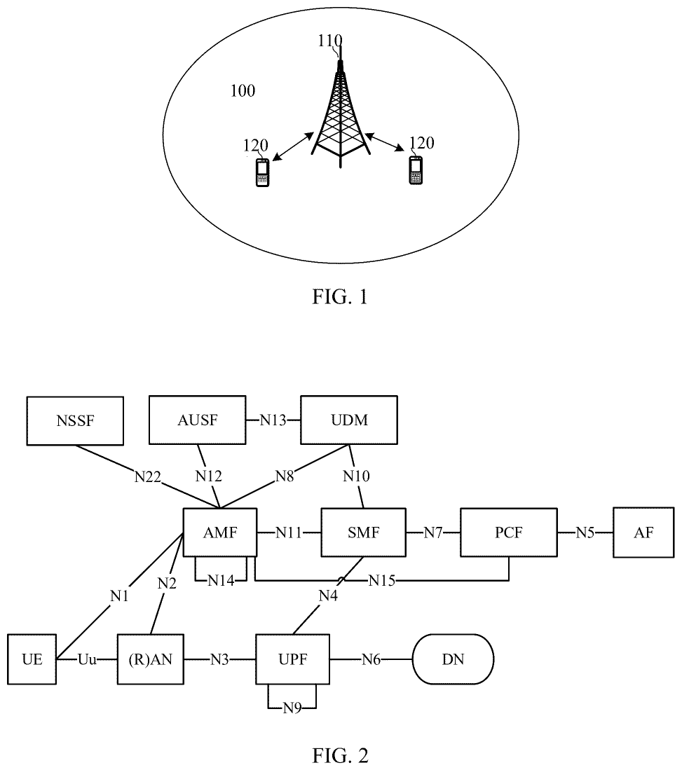

FIG. 1 is an example diagram of a system architecture of a wireless communications system 100 to which embodiments of this application are applicable. The wireless communications system 100 may include a network device 110 and a UE 120. The network device 110 may be a device in communication with the UE 120. The network device 110 may provide network coverage for a specific geographic area, and may communicate with the UE 120 located within the coverage. The UE 120 may access a network (for example, a wireless network) by using the network device 110. Optionally, the wireless communications system 100 may further include another network entity such as a network controller or a mobility management entity. This is not limited in embodiments of this application.

It should be understood that technical solutions of embodiments of this application may be applied to various communications systems, such as a 5th generation (5G) system or NR system, a long term evolution (LTE) system, an LTE frequency division duplex (FDD) system, and LTE time division duplex (TDD) system. The technical solutions provided in this application may further be applied to a future communications system, such as a 6th generation mobile communications system or a satellite communications system.

The UE in embodiments of this application may also be referred to as a terminal device, an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus. The UE in embodiments of this application may be a device providing a user with voice and/or data connectivity and capable of connecting people, objects, and machines, such as a handheld device or vehicle-mounted device having a wireless connection function. The UE in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, or the like. Optionally, the UE may be configured to function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart home device communicate with each other, without relaying a communication signal by using a base station.

The network device in embodiments of this application may be a device configured to communicate with the UE. The network device may be, for example, an access network device or a wireless access network device. For example, the network device may be a base station. The base station may broadly cover various names in the following, or may be replaced with the following names: a NodeB, an evolved NodeB (eNB), a next generation NodeB (gNB), a relay station, an access point, a transmitting and receiving point (TRP), a transmitting point (TP), a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof.

UEs may communicate with each other through a sidelink. Sidelink communication may alternatively be referred to as proximity service (ProSe) communication, unilateral communication, sidelink communication, or device-to-device (D2D) communication.

### Architecture of a Core Network

The core network is a crucial component part of the wireless communications system. FIG. 2 is an architectural diagram of a core network of an NR system. As shown in FIG. 2, the core network of the NR system may include one or more of the following functional entities: an access and mobility management function (AMF), a session management function (SMF), a policy control function (PCF), a user plane function (UPF), an application function (AF), a network slice selection function (NSSF), an authentication server function (AUSF), a unified data management (UDM), or the like. The functional entities are briefly described below.

The AMF is a network element that is in the core network and that is responsible for mobility management. In addition to performing mobility management on a UE, the AMF may further be responsible for forwarding a message related to session management between the UE and the SMF.

The SMF is a network element that is in the core network and that is responsible for session management. In addition to the session management, the SMF may further be responsible for one or more of the following tasks: allocating and managing an internet protocol (IP) address of the UE, selecting a manageable user plane function, policy control, a termination point of a charging function interface, a downlink data notification, configuring routing information for the user plane function, or the like.

The UPF is a user plane network element in the core network. The UPF may be responsible for forwarding and receiving user data of the UE. For example, the UPF may receive user data from a data network (DN), and transmit the user data to the UE by using an access network device. Alternatively, the UPF may receive, by using an access network device, the user data transmitted by the UE, and forward the user data to a DN. A transmission resource and a scheduling function that are in the UPF and that serve the UE may be managed and controlled by the SMF.

The PCF is a network element that is in the core network and that is responsible for policy control. The PCF may be responsible for formulating policies related to mobility management of the UE, session management, charging, and the like.

The AF mainly supports an interaction with a 3rd generation partnership project (3GPP) core network to provide a service. In other words, the AF may be configured to transfer a requirement of an application side on a network side. In some embodiments, the AF may be understood as a third-party server. For example, the AF may be an application server on the internet. In some embodiments, the AF may alternatively be a content provider (CP).

### U2N Relay

It is proposed in the 3GPP R17 (Release 17) that a solution to a short-range communication service is designed by using a ProSe project. Based on a ProSe, a wireless communications system may be enabled to support one or more new service forms. For example, with continuous development of 5G applications, a network controlled interactive service (NCIS) service is introduced into a standard as a new service form for a related standardization service. The NCIS service is mainly targeted at applications such as augmented reality (AR)/virtual reality (VR) and a game. Therefore, the NCIS service has high requirements for indicators such as a rate, a latency, a packet loss rate, and encoding and decoding. For example, for a VR game, a transmission rate of service data needs to reach 10 Gbps, and a packet loss rate cannot exceed 10E-4. A session established for the NCIS service is an NCIS session. UEs in a same NCIS session may be considered to form an NCIS group, for example, forming a team in a game. Establishment of the ProSe project may enable the wireless communications system to better support an interactive service, such as AR/VR.

An important scenario of the ProSe project is a U2N relay scenario. The U2N relay is to relay data of a remote UE for the remote UE by using a relay UE, so that the remote UE can communicate with a network device. The U2N relay includes a U2N relay based on a layer 2 and a U2N relay based on a layer 3.

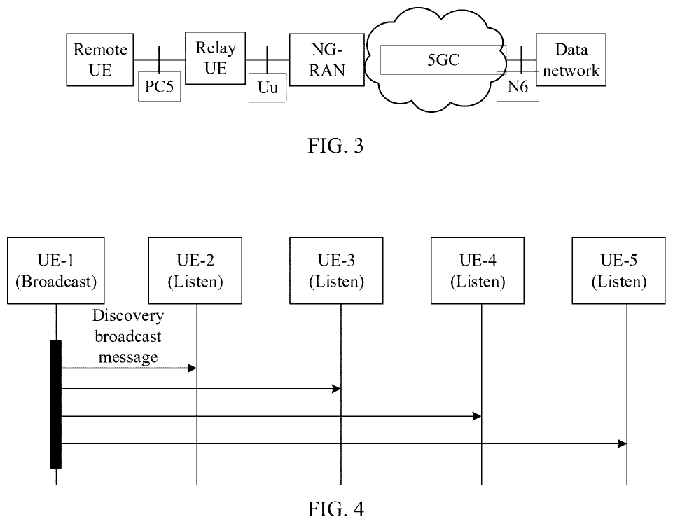

FIG. 3 is an example diagram of a system architecture of the U2N relay based on the layer 3. It may be seen in FIG. 3 that, a direct link (a PC5 link) is established between the remote UE and the relay UE, and the relay UE is connected to the network device through an air interface (a Uu interface). The relay UE may relay the data from the remote UE for the remote UE by using a protocol data unit (PDU) session. A corresponding data type is configured for each PDU session. The data type may include, for example, one or more of the following data types: the internet protocol version 4 (IPv4), the internet protocol version 6 (IPv6), an ethernet, or unstructured. For each PDU session, only a data type corresponding to the PDU session can be transmitted by using the PDU session.

To implement relay communication, the relay UE and the remote UE need to obtain necessary configuration parameters before performing the relay communication. The configuration parameters may come from the PCF or an application server, or may be pre-configured in a UE or a subscriber identity module (SIM) card of a UE. In addition, before transmitting data, the remote UE needs to first discover a suitable relay UE, and establish a direct link to the relay UE.

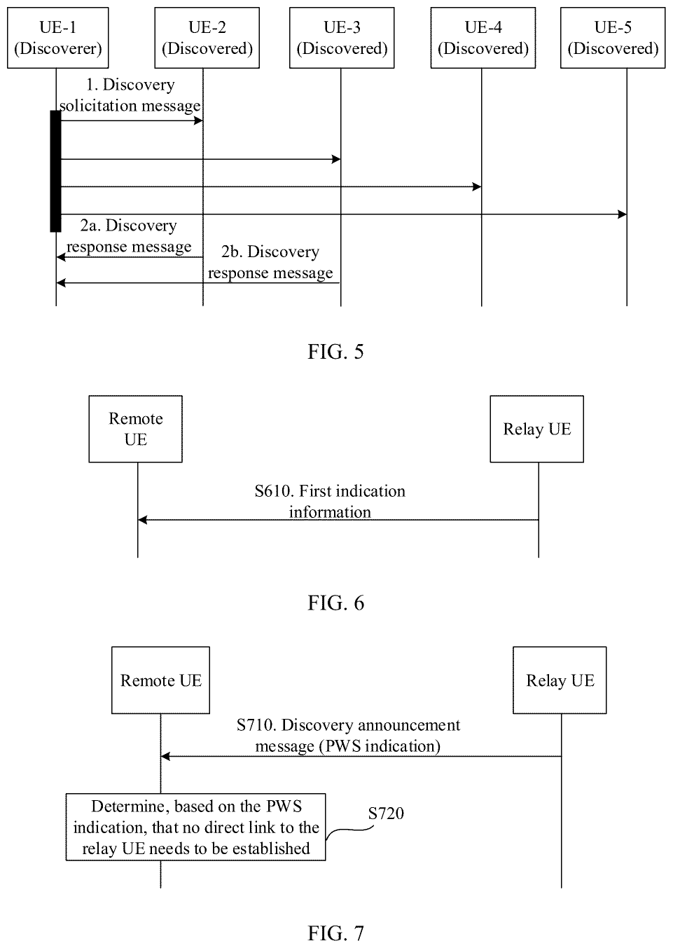

A process of discovering the relay UE may include two discovery modes that are respectively a mode A and a mode B. FIG. 4 shows a discovery procedure based on the mode A. As shown in FIG. 4, in the mode A, the relay UE transmits (or broadcasts, for example, periodically broadcasts) a discovery announcement message, and a relay service code (RSC) of a relay service that can be provided by the relay UE is carried in the discovery announcement message. FIG. 5 shows a discovery procedure based on the mode B. As shown in FIG. 5, in the mode B, the remote UE proactively transmits a discovery solicitation message, and an RSC of a relay service required by the remote UE is carried in the discovery solicitation message. The remote UE then discovers and selects the relay UE by using a discovery response message returned by the relay UE. After the discovery procedure is ended, the relay UE and the remote UE may establish a PC5 connection.

### Public Warning System

In the public warning system (PWS), a network device (for example, a base station) transmits a public warning message to a UE within coverage of the network device by using system broadcast information. The public warning message may be used to notify the UE of warning information related to an earthquake, a tsunami, and/or the like.

Some standards (for example, refer to the document S2-2307647 approved at the 3GPP SA2 #157 meeting) standardize that the relay UE relays the public warning information to the remote UE. The standards specify that the relay UE may relay the public warning information to the remote UE, and that during the relaying of the public warning message, the remote UE is not required to establish a direct link (or a PC5 connection) to the relay UE. In other words, the relay UE may broadcast the public warning information to the remote UE. To support reception of the public warning message, the network device configures, for the relay UE and the remote UE, parameters such as a layer 2 identifier (L2 ID) and quality of service (QoS) for transmitting and receiving the public warning message.

Currently, the standards specify that the relay UE may transmit a warning message (for example, the public warning message mentioned above) in a broadcast manner. However, there is currently no clear solution to a specific implementation, for example, whether the relay UE needs to establish a direct connection to the remote UE; for another example, how the relay UE broadcasts the warning message; or for another example, when the remote UE is required to receive the warning message.

To address one or more of the foregoing problems, indication information (referred to as first indication information below) associated with the warning message is introduced in embodiments of this application. In a scenario of transmitting the warning message, the relay UE may transmit the first indication information to the remote UE (refer to step S610 in FIG. 6), to facilitate the transmission of the warning message.

The relay UE may transmit the first indication information to a specific remote UE or an unspecific remote UE. For example, the relay UE transmitting the first indication information to the unspecific remote UE may be the relay UE broadcasting the first indication information. In some embodiments, step S610 may be replaced by the relay UE transmitting or broadcasting the first indication information.

In embodiments of this application, a transmitting occasion or a carrying manner of the first indication information is not specific limited. The following provides two possible implementations with reference to Embodiments 1 and 2.

### Embodiment 1: The First Indication Information is Transmitted by Using a First Discovery Message (or the First Indication Information is Carried in a First Discovery Message)

In some embodiments, the first discovery message may be a discovery announcement message. That is, a discovery procedure between a relay UE and a remote UE may be performed in the mode A. In the mode A, the relay UE broadcasts the discovery announcement message. While broadcasting the discovery announcement message, the relay UE may add the first indication information in the discovery announcement message.

In some embodiments, the first discovery message may be a discovery response message. That is, a discovery procedure between a relay UE and a remote UE may be performed in the mode B. In the mode B, the remote UE first transmits the discovery solicitation message. After receiving the discovery solicitation message, if the relay UE determines to provide a service to the remote UE, the relay UE transmits the discovery response message to the remote UE. While transmitting the discovery response message, the relay UE may add the first indication information in the discovery response message.

In some embodiments, the first indication information may be used to indicate a warning message (such as a public warning message or a PWS message). Therefore, in this embodiment, the first indication information may alternatively be referred to as a warning message indication information, or a warning message indication (for example, a public warning message indication). Alternatively, the first indication information may alternatively be referred to as a public warning system indication (PWS indication).

In some embodiments, the first indication information may be used to indicate that the relay UE is capable of relaying the warning message.

In some embodiments, the first indication information may be used to indicate not establishing a direct link (or that no direct link needs to be established) between the relay UE and the remote UE. In some embodiments, if the first indication information indicates that no direct link needs to be established between the relay UE and the remote UE, it may indicate that the relay UE can relay the warning message (because the warning message may be transmitted in a broadcast manner without the direct link).

In some embodiments, the first indication information may be used to indicate both that the relay UE is capable of relaying the warning message and that no direct link needs to be established between the relay UE and the remote UE.

For example, the first indication information may be represented by two bits. If values of the two bits are a first value (for example, “01”), it may indicate that the relay UE can relay the warning message. If values of the two bits are a second value (for example, “10”), it may indicate that no direct link needs to be established between the relay UE and the remote UE. If values of the two bits are a third value (for example, “11”), it may indicate that the relay UE can relay the warning message and that no direct link needs to be established between the relay UE and the remote UE.

In some embodiments, the first indication information may be a relay service code (or indicated by using a relay service code). For example, if a value of the relay service code is a first value, it may indicate that the relay service code is the first indication information or indicates the first indication information. For example, the first value may be a particular value of the relay service code.

In some embodiments, the first indication information may be a new parameter (or indicated by using a new parameter). For example, a new parameter may be added to the first discovery message (such as the discovery announcement message or the discovery response message), and may be used to indicate the first indication information.

The new parameter may be an information element (IE) in the first discovery message. The IE may include an ID, also known as an IEI. That is, if the first discovery message includes the IE including the ID, it indicates that the first discovery message includes the first indication information. Alternatively, in addition to the ID, the IE further includes one or more fields. The one or more fields may include one or more bits. The first indication information may be indicated based on the one or more bits. Alternatively, the IE may be represented by one bit.

In some embodiments, the first indication information may include the warning message. For example, the first indication information may be a container including the warning message. Further, in some embodiments, the remote UE may obtain the warning message from the first indication information. For example, the remote UE may find the container in the first discovery message, and extract the warning message from the container.

In some embodiments, if the first discovery message is the discovery response message, the discovery solicitation message transmitted by the remote UE may include second indication information. The second indication information may be indication information associated with the warning message. The second indication information may be used to indicate that the remote UE expects or needs to receive the warning message. Alternatively, the second indication information may be used to indicate that the remote UE expects or needs to receive the warning message relayed by the relay UE. In some embodiments, the second indication information may be referred to as a warning message request indication or a public warning system request indication (PWS request indication).

In some embodiments, the second indication information may be used to indicate that the remote UE does not expect to establish a direct link to the relay UE. In some embodiments, the second indication information indicating that the remote UE does not expect to establish a direct link to the relay UE can indicate that the remote UE needs to receive the warning message relayed by the relay UE in a broadcast manner.

In some embodiments, the second indication information may be used to indicate both that the remote UE expects or needs to receive the warning message and that the remote UE does not expect to establish a direct link to the relay UE.

In some embodiments, the second indication information may be a relay service code (or indicated by a relay service code). For example, if a value of the relay service code is a second value, the relay service code represents the second indication information. For example, the second value may be a particular value of the relay service code. Alternatively, in some embodiments, the first indication information and the second indication information may be a first RSC and a second RSC, respectively, and the first RSC and the second RSC have a same value.

In some embodiments, the second indication information may be a new parameter (or indicated by using a new parameter). For example, a new parameter may be added to the discovery solicitation message, and the parameter is used to indicate the second indication information. For example, the new parameter may be an IE in the discovery solicitation message. The IE may include an ID, also known as an IEI. That is, if the discovery solicitation message includes the IE including the ID, it indicates that the discovery solicitation message includes the second indication information. Alternatively, in addition to the ID, the IE further includes one or more fields. The one or more fields may include one or more bits. The second indication information may be indicated based on the one or more bits. Alternatively, the IE may be represented by one bit.

Further, in some embodiments, the first indication information and the second indication information may be represented by using a same parameter.

In some embodiments, after the relay UE transmits the first indication information (for example, the first indication information transmitted by using the first discovery message) to the remote UE, the remote UE may not establish the direct link to the relay UE.

In some embodiments, after the relay UE transmits the first indication information to the remote UE, the remote UE may begin to listen to the warning message relayed by the relay UE. In other words, the remote UE does not need to continuously listen to the warning message relayed by the relay UE. Instead, after receiving the first indication information, the remote UE begins to listen to the warning message relayed by the relay UE, thereby reducing power consumption of the remote UE. For example, the remote UE may establish a receiving-end QoS flow based on a QoS parameter configured by a network device. Then, the remote UE may receive the warning message through the QoS flow based on a layer 2 identifier corresponding to the warning message configured by the network device.

In some embodiments, after the relay UE transmits the first indication information to the remote UE, the remote UE may determine, based on the first indication information, that no direct link to the relay UE needs to be established, and begin to listen to the warning message relayed by the relay UE. It may be seen that, in this embodiment, the remote UE can listen to and attempt to receive the warning message without establishing a direct link to the relay UE.

In some embodiments, after the relay UE transmits the first indication information to the remote UE, the remote UE may establish the direct link to the relay UE. For example, the direct link can be used to transmit service data other than the warning message between the remote UE and the relay UE. Furthermore, the relay UE may begin to listen to the warning message relayed by the relay UE. For example, the remote UE learns, based on the first indication information, that the relay UE relays the warning message. Therefore, the remote UE may first establish the direct link to the relay UE, to transmit the service data other than the warning message. After completing establishment of the direct link, the remote UE may begin to listen to and receive the warning message.

In some embodiments, the warning message may be transmitted through the direct link between the relay UE and the remote UE.

### Embodiment 2: The First Indication Information is Transmitted Through a Direct Link

In Embodiment 1, the first indication information is transmitted by using a discovery message. Different from Embodiment 1, in Embodiment 2, a relay UE transmits the first indication information through a direct link between the relay UE and a remote UE.

In some embodiments, the first indication information is carried in first signaling, and the first signaling is signaling transmitted on the direct link between the relay UE and the remote UE.

In some embodiments, the first signaling may be signaling in a ProSe layer.

In some embodiments, the first signaling may be signaling in a PC5 interface-radio resource control (PC5-RRC) layer.

In some embodiments, if the first signaling is the signaling in the PC5-RRC layer, the PC5-RRC layer may notify the ProSe layer that a PWS message needs to be received.

In some embodiments, the first indication information may be triggered by a network device. For example, the relay UE may receive third indication information transmitted by the network device. The third indication information may be used to instruct the relay UE to receive a warning message, or the third indication information may be used to instruct the relay UE to relay a warning message to the remote UE. After receiving the third indication information, the relay UE transmits the first indication information to the remote UE.

In some embodiments, the network device may be a base station or a core network element (for example, an AMF).

In some embodiments, the first indication information may be used to instruct the relay UE to prepare to transmit the warning message, or to instruct the remote UE to receive the warning message.

In some embodiments, after the relay UE transmits the first indication information to the remote UE, the remote UE may begin to listen to the warning message relayed by the relay UE. In other words, the remote UE does not need to continuously listen to the warning message relayed by the relay UE. Instead, after receiving the first indication information, the remote UE begins to listen to the warning message relayed by the relay UE, thereby reducing power consumption of the remote UE. For example, the remote UE may establish a receiving-end QoS flow based on a QoS parameter configured by the network device. Then, the remote UE may receive the warning message through the QoS flow based on a layer 2 identifier corresponding to the warning message configured by the network device.

In some embodiments, the warning message may be transmitted through the direct link between the relay UE and the remote UE.

It should be understood that the warning message mentioned in embodiments of this application may refer to or be replaced by a public warning message or a public warning system message. For example, the warning message may indicate information related to an earthquake and/or a tsunami.

It should further be understood that the direct link mentioned in embodiments of this application may, for example, refer to a PC5 link. Alternatively, the direct link mentioned in embodiments of this application may refer to a link used for unicast transmission.

Embodiments of this application are described in more detail below by using FIG. 7 to FIG. 9 as examples. In the examples in FIG. 7 to FIG. 9, the first indication information mentioned above is exemplarily referred to as a PWS indication, the second indication information is exemplarily referred to as a PWS request indication, and the warning message is exemplarily referred to as a PWS message. It should be noted that, the examples in FIG. 7 to FIG. 9 are merely intended to help a person skilled in the art understand embodiments of this application, and are not intended to limit embodiments of this application to a specific value or a specific scenario that is exemplified. Apparently, a person skilled in the art may perform various equivalent modifications or changes based on the examples provided in FIG. 7 to FIG. 9, and such modifications or changes also fall within the scope of embodiments of this application.

FIG. 7 is an example diagram of a wireless communication method according to an embodiment of this application. In an example in FIG. 7, a discovery procedure based on a mode A is performed between a remote UE and a relay UE, and a PWS indication is carried in a discovery announcement message.

As shown in FIG. 7, in step S710, the relay UE transmits the discovery announcement message. The discovery announcement message includes the PWS indication. The PWS indication may indicate that the relay UE can relay a PWS message. Alternatively, the PWS indication may indicate that no direct link needs to be established. The PWS indication may be a particular value of an RSC. Alternatively, the PWS indication may be a new parameter (for example, an IE) carried in the discovery announcement message. The new parameter may include an IE identifier. Alternatively, the new parameter may include an IEI and one or more fields, and the one or more fields may include one or more bits. If a value of a bit in the one or more bits is set to “1”, it indicates that the parameter is the PWS indication. Alternatively, the new parameter may be a container including the PWS message.

Still as shown in FIG. 7, in step S720, the remote UE determines, based on the PWS indication, that no direct link to the relay UE needs to be established. Further, the remote UE begins to listen to the PWS message relayed by the relay UE.

Alternatively, if the PWS indication is carried in the new parameter in the discovery announcement message, and the new parameter is a container including the PWS message, the remote UE may obtain the warning message from the container.

Alternatively, the remote UE still establishes a direct link to the relay UE. The direct link may be used to transmit a service other than the PWS message. Further, the remote UE may learn, based on the PWS indication, that the relay UE will relay the PWS message. Therefore, after completing establishment of the direct link, the remote UE begins to listen to and receives the PWS message.

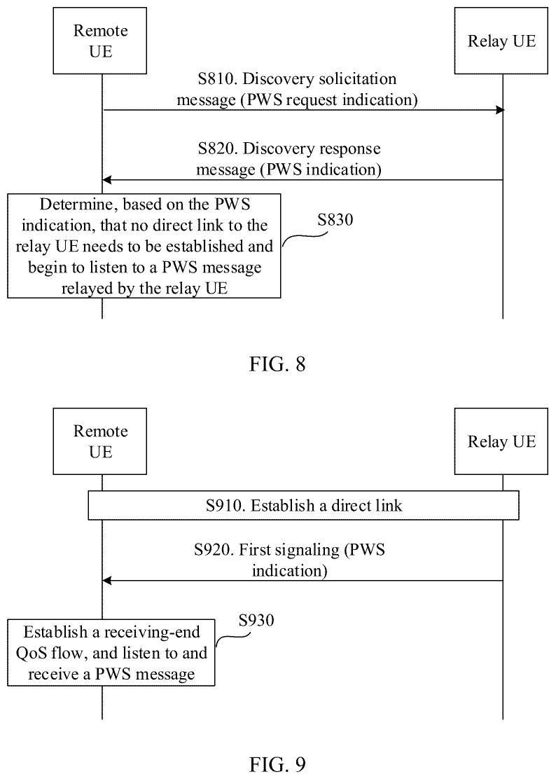

FIG. 8 is another example diagram of a wireless communication method according to an embodiment of this application. In an example in FIG. 8, a discovery procedure based on a mode B is performed between a remote UE and a relay UE, and a PWS indication is carried in a discovery response message.

As shown in FIG. 8, in step S810, in a case that the remote UE needs to search for the relay UE that can relay a PWS message, the remote UE transmits a discovery solicitation message. The discovery solicitation message includes a PWS request indication. The PWS request indication may indicate that the remote UE needs to receive a relayed PWS message. Alternatively, the PWS request indication may indicate that the remote UE does not expect to establish a direct link. The PWS request indication may be a particular value of an RSC. Alternatively, the PWS indication may be a new parameter in the discovery solicitation message.

After receiving the discovery solicitation message, the relay UE may learn, based on the PWS request indication in the discovery solicitation message, that the remote UE needs to receive the PWS message. Still as shown in FIG. 8, in step S820, if the relay UE can relay the PWS message, the relay UE transmits the discovery response message including a PWS indication. The PWS indication may indicate that the relay UE can relay the PWS message. Alternatively, the PWS indication may indicate that no direct link needs to be established.

The PWS indication may be a particular value of an RSC. Further, in some embodiments, the PWS request indication and the PWS indication may be a first RSC and a second RSC, respectively, and the first RSC and the second RSC have a same value.

Alternatively, the PWS indication may be a new parameter carried in a discovery announcement message. The new parameter may include a parameter identifier. Alternatively, the new parameter may include a parameter identifier and one or more fields. The one or more fields may include one or more bits. If a value of a bit in the one or more bits is set to “1”, it indicates the PWS indication. Alternatively, the new parameter may be a container including the PWS message. Further, in some embodiments, the PWS request indication and the PWS indication may correspond to a same parameter.

Still as shown in FIG. 8, in step S830, the remote UE determines, based on the PWS indication, that no direct link to the relay UE needs to be established and begins to listen to the PWS message relayed by the relay UE. In other words, the relay of the PWS message may be implemented without establishing a direct link between the remote UE and the relay UE.

Alternatively, the remote UE still establishes a direct link to the relay UE. The direct link may be used to transmit a service other than the PWS message. Further, the remote UE may learn, based on the PWS indication, that the relay UE will relay the PWS message. Therefore, after completing establishment of the direct link, the remote UE begins to listen to and receives the PWS message.

FIG. 9 is another example diagram of a wireless communication method according to an embodiment of this application. In an example in FIG. 9, a direct link is first established between a remote UE and a relay UE. The relay UE then transmits, to the remote UE through the direct link, first signaling carrying a PWS indication, thereby instructing the remote UE to begin to listen to a PWS message.

As shown in FIG. 9, in step S910, the remote UE and the relay UE establish the direct link. The direct link may be established based on a discovery procedure.

In step S920, when the relay UE needs to relay the PWS message, the relay UE transmits the first signaling to the remote UE.

For example, when the relay UE receives an indication indicating relaying the PWS message and transmitted by a base station or a core network element (for example, an AMF), the relay UE transmits the first signaling to the remote UE.

The first signaling may carry the PWS indication. The PWS indication may be used to indicate to the remote UE that a PWS message needs to be received.

The first signaling may be signaling in a ProSe layer. Alternatively, the first signaling may be signaling in a PC5-RRC layer.

In step S930, after receiving the PWS indication, the remote UE establishes a receiving-end QoS flow based on a QoS parameter configured by a network device. The remote UE may then begin to listen to and receive the PWS message. In addition, if the PWS indication is transmitted by using the signaling in the PC5 RRC layer, the PC5 RRC layer may notify the ProSe layer that the PWS message needs to be received.

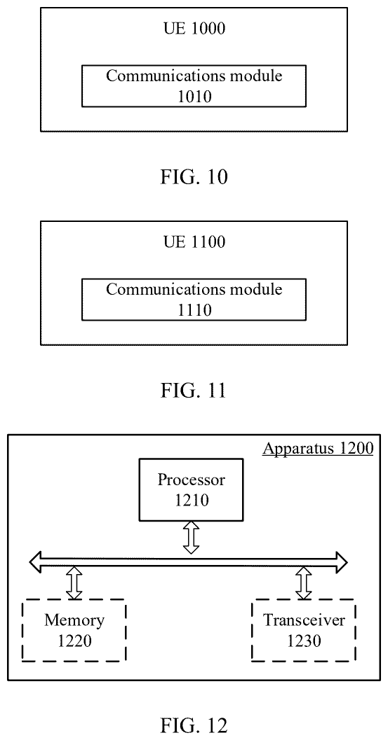

The method embodiments of this application are described above in detail with reference to FIG. 1 to FIG. 9. Apparatus embodiments of this application are described below in detail with reference to FIG. 10 to FIG. 12. It should be understood that the descriptions of the method embodiments correspond to the descriptions of the apparatus embodiments, and therefore, for a part that is not described in detail, reference may be made to the foregoing method embodiments.

FIG. 10 is a schematic diagram of a structure of a UE according to an embodiment of this application. The UE 1000 in FIG. 10 may be the relay UE mentioned above. The relay UE includes a communications module 1010. The communications module 1010 may be configured to transmit first indication information to a remote UE. The first indication information is associated with a warning message.

In some embodiments, the first indication information is carried in a first discovery message.

In some embodiments, the first discovery message is a discovery announcement message or a discovery response message.

In some embodiments, if the first discovery message is the discovery response message, the communications module 1010 is further configured to: before the relay UE transmits the first indication information to the remote UE, receive a discovery solicitation message transmitted by the remote UE. The discovery request message includes second indication information, and the second indication information is used to indicate one or more of the following: the remote UE expects to receive the warning message; or the remote UE does not expect to establish a direct link to the relay UE.

In some embodiments, the second indication information is a relay service code.

In some embodiments, the first indication information is used to indicate one or more of the following: the relay UE is capable of relaying the warning message; or no direct link needs to be established between the relay UE and the remote UE.

In some embodiments, the first indication information is a relay service code; or the first indication information includes the warning message.

In some embodiments, after the relay UE transmits the first indication information to the remote UE, the relay UE does not establish a direct link to the remote UE; or after the relay UE transmits the first indication information to the remote UE, the relay UE performs transmission of service data other than the warning message with the remote UE through a direct link.

In some embodiments, the first indication information is carried in first signaling, and the first signaling is signaling transmitted on a direct link between the relay UE and the remote UE.

In some embodiments, the first signaling is signaling in a ProSe layer or a PC5-RRC layer.

In some embodiments, the communications module 1010 is further configured to: before the relay UE transmits the first indication information to the remote UE, receive third indication information transmitted by a network device. The third indication information is used to instruct the relay UE to relay the warning message to the remote UE.

In some embodiments, the first indication information is used to instruct the remote UE to receive the warning message.

FIG. 11 is a schematic diagram of a structure of a UE according to another embodiment of this application. The UE 1100 in FIG. 11 may be the remote UE mentioned above. The remote UE includes a communications module 1110. The communications module 1110 may be configured to receive first indication information transmitted by a relay UE. The first indication information is associated with a warning message.

In some embodiments, the first indication information is carried in a first discovery message.

In some embodiments, the first discovery message is a discovery announcement message or a discovery response message.

In some embodiments, if the first discovery message is the discovery response message, the communications module 1110 is further configured to: before the remote UE receives the first indication information transmitted by the relay UE, transmit a discovery solicitation message to the relay UE. The discovery solicitation message includes second indication information, and the second indication information is used to indicate one or more of the following: the remote UE expects to receive the warning message; or the remote UE does not expect to establish a direct link to the relay UE.

In some embodiments, the second indication information is a relay service code.

In some embodiments, the first indication information is used to indicate one or more of the following: the relay UE is capable of relaying the warning message; or no direct link needs to be established between the relay UE and the remote UE.

In some embodiments, the first indication information is a relay service code; or the first indication information includes the warning message.

In some embodiments, after the remote UE receives the first indication information transmitted by the relay UE, the remote UE does not establish a direct link to the relay UE; or after the remote UE receives the first indication information transmitted by the remote UE, the remote UE performs transmission of service data other than the warning message with the relay UE through a direct link.

In some embodiments, the first indication information is carried in first signaling, and the first signaling is signaling transmitted on a direct link between the relay UE and the remote UE.

In some embodiments, the first signaling is signaling in a ProSe layer or a PC5-RRC layer.

In some embodiments, the first indication information is used to instruct the remote UE to receive the warning message.

In some embodiments, the remote UE further includes: a processing module, configured to: after the remote UE receives the first indication information transmitted by the relay UE, listen to the warning message broadcast by the relay UE; or obtain the warning message from the first indication information.

FIG. 12 is a schematic diagram of a structure of a communications apparatus according to an embodiment of this application. Dashed lines in FIG. 12 indicate that a unit or module is optional. The apparatus 1200 may be configured to implement the methods described in the foregoing method embodiments. The apparatus 1200 may be a chip, a UE, or a network device.

The apparatus 1200 may include one or more processors 1210. The processor 1210 may support the apparatus 1200 in implementing the methods described in the foregoing method embodiments. The processor 1210 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 1200 may further include one or more memories 1220. The memory 1220 stores a program, and the program may be executed by the processor 1210, to cause the processor 1210 to execute the methods described in the foregoing method embodiments. The memory 1220 may be separated from or integrated into the processor 1210.

The apparatus 1200 may further include a transceiver 1230. The processor 1210 may communicate with another device or chip by using the transceiver 1230. For example, the processor 1210 may transmit data to and receive data from another device or chip by using the transceiver 1230.

An embodiment of this application further provides a computer-readable storage medium for storing a program. The computer-readable storage medium may be applied to the terminal or the network device provided in embodiments of this application, and the program causes a computer to perform the methods to be performed by the terminal or the network device in various embodiments of this application.

An embodiment of this application further provides a computer program product. The computer program product includes a program. The computer program product may be applied to the terminal or the network device provided in embodiments of this application, and the program causes a computer to perform the methods to be performed by the terminal or the network device in various embodiments of this application.

An embodiment of this application further provides a computer program. The computer program may be applied to the terminal or the network device provided in embodiments of this application, and the computer program causes a computer to perform the methods to be performed by the terminal or the network device in various embodiments of this application.

It should be understood that the terms “system” and “network” in this application may be used interchangeably. In addition, the terms used in this application are only used to explain the specific embodiments of this application, and are not intended to limit this application. The terms “first”, “second”, “third”, “fourth”, and the like in the specification, claims, and drawings of this application are used to distinguish between different objects, rather than to describe a specific order. In addition, the terms “include” and “have” and any variations thereof are intended to cover a non-exclusive inclusion.

In the embodiments of this application, “indicate” mentioned herein may refer to a direct indication, or may refer to an indirect indication, or may mean that there is an association relationship. For example, if A indicates B, it may mean that A directly indicates B, for example, B can be obtained from A. Alternatively, it may mean that A indirectly indicates B, for example, A indicates C, and B can be obtained from C. Alternatively, it may mean that there is an association relationship between A and B.

In embodiments of this application, “B corresponding to A” means that B is associated with A, and B may be determined based on A. However, it should be further understood that, determining B based on A does not mean determining B based only on A, but instead, B may be determined based on A and/or other information.

In embodiments of this application, the term “correspond” may mean that there is a direct or indirect correspondence between the two, or may mean that there is an association relationship between the two, or may mean that there is a relationship such as indicating and being indicated, or configuring and being configured.

In embodiments of this application, “predefined” or “pre-configured” may be implemented by prestoring corresponding code, tables, or other forms that may be used to indicate related information in devices (for example, including a UE and a network device), and a specific implementation thereof is not limited in this application. For example, being pre-defined may refer to being defined in a protocol.

In embodiments of this application, the “protocol” may refer to a standard protocol in the communications field, and may include, for example, an LTE protocol, an NR protocol, and a related protocol applied to a future communications system, which is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (for example, through a coaxial cable, an optical fiber, or a digital subscriber line (DSL)) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A user equipment (UE), wherein the UE is a relay UE, and the relay UE comprises a transceiver, a memory, and a processor, wherein the memory is configured to store a program, and the processor is configured to invoke the program in the memory and control the transceiver to receive or transmit a signal, to cause the relay UE to:
transmit first indication information to a remote UE, wherein the first indication information is associated with a warning message.

2. The UE according to claim 1, wherein the first indication information is carried in a first discovery message;
wherein the first discovery message is a discovery announcement message or a discovery response message.

3. The UE according to claim 2, wherein if the first discovery message is the discovery response message, before transmitting the first indication information to the remote UE, the relay UE is further caused to:
receive a discovery solicitation message transmitted by the remote UE, wherein the discovery solicitation message comprises second indication information, and the second indication information is used to indicate one or more of the following:
the remote UE expects to receive the warning message; or
the remote UE does not expect to establish a direct link to the relay UE.

4. The UE according to claim 3, wherein the second indication information is a relay service code.

5. The UE according to claim 1, wherein the first indication information is used to indicate one or more of the following:
the relay UE is capable of relaying the warning message; or
no direct link needs to be established between the relay UE and the remote UE.

6. The UE according to claim 1, wherein
the first indication information is a relay service code; or
the first indication information comprises the warning message.

7. The UE according to claim 1, wherein
after transmitting the first indication information to the remote UE, the relay UE does not establish a direct link to the remote UE; or
after transmitting the first indication information to the remote UE, the relay UE performs transmission of service data other than the warning message with the remote UE through a direct link.

8. The UE according to claim 1, wherein the first indication information is carried in first signaling, and the first signaling is signaling transmitted on a direct link between the relay UE and the remote UE,
wherein the first signaling is signaling in a proximity service (ProSe) layer or a PC5 interface-radio resource control (PC5-RRC) layer.

9. The UE according to claim 8, wherein before transmitting the first indication information to the remote UE, the relay UE is further caused to:
receive third indication information transmitted by a network device, wherein the third indication information is used to instruct the relay UE to relay the warning message to the remote UE.

10. The UE according to claim 8, wherein the first indication information is used to instruct the remote UE to receive the warning message.

11. A user equipment (UE), wherein the UE is a remote UE, and the remote UE comprises a transceiver, a memory, and a processor, wherein the memory is configured to store a program, and the processor is configured to invoke the program in the memory and control the transceiver to receive or transmit a signal, to cause the remote UE to:
receive first indication information transmitted by a relay UE, wherein the first indication information is associated with a warning message.

12. The UE according to claim 11, wherein the first indication information is carried in a first discovery message;
wherein the first discovery message is a discovery announcement message or a discovery response message.

13. The UE according to claim 12, wherein if the first discovery message is the discovery response message, before receiving the first indication information transmitted by the relay UE, the remote UE is further caused to:
transmit a discovery solicitation message to the relay UE, wherein the discovery solicitation message comprises second indication information, and the second indication information is used to indicate one or more of the following:
the remote UE expects to receive the warning message; or
the remote UE does not expect to establish a direct link to the relay UE.

14. The UE according to claim 13, wherein the second indication information is a relay service code.

15. The UE according to claim 11, wherein the first indication information is used to indicate one or more of the following:
the relay UE is capable of relaying the warning message; or
no direct link needs to be established between the relay UE and the remote UE.

16. The UE according to claim 11, wherein
the first indication information is a relay service code; or
the first indication information comprises the warning message.

17. The UE according to claim 11, wherein
after receiving the first indication information transmitted by the relay UE, the remote UE does not establish a direct link to the remote UE; or
after receiving the first indication information transmitted by the relay UE, the remote UE performs transmission of service data other than the warning message with the relay UE through a direct link.

18. The UE according to claim 11, wherein the first indication information is carried in first signaling, and the first signaling is signaling transmitted on a direct link between the relay UE and the remote UE;
wherein the first signaling is signaling in a proximity service (ProSe) layer or a PC5 interface-radio resource control (PC5-RRC) layer.

19. The UE according to claim 18, wherein the first indication information is used to instruct the remote UE to receive the warning message.

20. The UE according to claim 11, wherein after receiving the first indication information transmitted by the relay UE, the remote UE is further caused to:
listen to the warning message broadcast by the relay UE; or
obtain the warning message from the first indication information.
